(19) United States
(12) Patent Application Publication
(10) Pub. No.: US 2025/0276672 A1
(43) Pub. Date: Sep. 4, 2025

(54) TIRE INFLATION TOOL WITH VALVE REMOVAL FUNCTION

(71) Applicants: LUNG-KUO HSU, Changhua County (TW); CREATE FOREVER INDUSTRIAL CO., LTD., Changhua County (TW)

(72) Inventor: LUNG-KUO HSU, Changhua County (TW)

(21) Appl. No.: 19/023,910

(22) Filed: Jan. 16, 2025

(30) Foreign Application Priority Data
Mar. 2, 2024 (TW) 113107629

(51) Int. Cl. B60S 5/04

(52) U.S. Cl. CPC B60S 5/04

(57) ABSTRACT

A tire inflation tool is configured to connect on a tire valve of a tire, and the tire valve includes an air valve. The tire inflation tool contains: a fitting tube, a driving rod, and an air connector. The fitting tube includes a first segment, a second segment, and an air conduit. An inlet joint is defined between the first segment and the second segment and is communicated with the air conduit, and a coupling portion is formed on the first segment. The driving rod is movable and rotatable reciprocally between a first position and a second position. The driving rod includes a manipulation portion and a take portion. When the driving rod actuates the air valve to move toward the second position, the tire is communicated with an external environment via the tire valve, the air conduit and the inlet joint, thus increasing an inflating area of air.

### TECHNICAL FIELD

The present invention relates to an inflation tool, and more particularly to a tire inflation tool with a valve removal function.

### BACKGROUND

Conventionally, tire inflation is executed by using a pumping device. The user will put an air connector of the pumping device on a tire valve and then inflate air into the tire. However, because an air valve is received in the tire valve, the air is inflated into the tire slowly and in small amounts, thus having a slow speed to inflate the air, a low inflation efficiency and a long inflation time, especially for the tire such as a truck tire, a longer inflation time is required.

To accelerate the speed to inflate the tire, a user applies a wrench to remove the air valve from the tire valve, thus communicating the tire valve smoothly. Then, the pumping device is connected to the tire valve to inflate the air quickly and in a large amount. But such an inflation way will apply two tools to cause an inconvenient operation. When removing or connecting the air valve, the user has to hold the air valve with one hand and rotate the wrench with the other hand to avoid removal of the air valve, thus having an inconvenient operation. In addition, when removing or replacing the air valve by using the wrench, an air leakage will occur greatly. In other words, such an inflation way cannot solve the speed of inflating the air and the air leakage.

To overcome the above-mentioned problem, a tire inflation tool has been developed to be operated with the user in one hand. For example, the air valve is removed from the tire valve, and air inflation is executed quickly and easily. Nevertheless, the inner threads of a fitting tube are screwed with the outer threads of the tire valve slowly and troublesomely with the user's two hands, and before and after the pumping device connects with the tire valve, a fixing device is operated troublesomely. Furthermore, a flexible pipe is forced into a receiving head at certain tightness, thus having difficult connection and high fabrication cost in the manufacturing process, and having a high failure rate and poor stability in using process. Therefore, the tire inflation tool cannot satisfy market demands.

The present invention has arisen to mitigate and/or obviate the afore-described disadvantages.

### SUMMARY

The primary aspect of the present invention is to provide a tire inflation tool that is connected with a tire valve of a tire by using an air connector to inflate air, and the air connector is removed from a tire valve by mating with a fitting tube and a driving rod, after inflating the air with a user's one hand, hence the air is inflated into the tire easily and quickly, and the air valve is removed, thus obtaining easy operation and time and labor-saving.

Another aspect of the present invention is to provide a tire inflation tool by which a take portion is simplified and connected easily, and a flexible block is connected with the take portion stably to reduce a fabrication cost and prolong a service life.

To obtain the above-mentioned aspect, a tire inflation tool provided by the present invention is configured to connect to a tire valve of a tire, the tire valve includes an air valve configured to inflate and discharge the air into and from the tire. The tire inflation tool contains: a fitting tube, a driving rod, and an air connector.

The fitting tube includes a first segment, a second segment opposite the first segment, and an air conduit communicating with the first segment and the second segment. An inlet joint is defined between the first segment and the second segment of the fitting tube and communicates with the air conduit, and a coupling portion is formed on the first segment of the fitting tube.

The driving rod is movable and rotatable reciprocally between a first position and a second position. The driving rod includes a manipulation portion extending out of an outer wall of the second segment of the fitting tube from an end of the driving rod, and a take portion formed on the other end of the driving rod. When the driving rod is moved toward the first position, the take portion is connected with the air valve of the tire valve and actuates the air valve to rotate so as to remove or connect the air valve from or with the tire valve. When the driving rod actuates the air valve to move toward the second position, the tire is communicated with an external environment via the tire valve, the air conduit and the inlet joint, thus increasing an inflating area of air.

The air connector includes a seat, an air stop ring, at least one movable retainer, a control element, and at least one returning element.

A seat has a first fixing orifice formed on an end thereof, a second fixing orifice formed on the other end of the seat, a channel defined and communicated between the first fixing orifice and the second fixing orifice. The first fixing orifice is configured to accommodate the coupling portion of the fitting tube, and the second fixing orifice is configured to accommodate the tire valve.

The air stop ring is received in the channel but not blocked by the first fixing orifice and the second fixing orifice, the air stop ring is moved toward the first fixing orifice or the second fixing orifice in the channel. The air stop ring has a passageway defined therein, and the air stop ring has an air-tight portion extending from an outer wall thereof to stop and close air with the channel.

A movable retainer is rotatably with the seat adjacent to the second orifice, the movable retainer has a toothed portion formed on an inner wall thereof and an actuation portion extending from an outer wall of the movable retainer. The toothed portion is controlled to move between an internal position and an external position, the internal position is located in the channel, and the external position is located outside the channel.

The at least one returning element is configured to abut against the movable retainer so as to maintain the toothed portion at the internal position, and when the at least one returning element actuates the actuation portion, and the toothed portion of the movable retainer is moved toward the external position.

### BRIEF DESCRIPTION OF THE DRAWINGS

FIG. 1 is a perspective view showing the assembly of a tire inflation tool according to a preferred embodiment of the present invention.

FIG. 2 is a cross-sectional perspective view showing the exploded components of the tire inflation tool according to the preferred embodiment of the present invention.

FIG. 3 is a cross-sectional view showing the exploded components of a driving rod of the tire inflation tool according to the preferred embodiment of the present invention.

FIG. 4 is a cross-sectional view showing the assembly of the tire inflation tool according to the preferred embodiment of the present invention.

FIG. 5 is a cross-sectional view showing the operation of the tire inflation tool according to the preferred embodiment of the present invention.

FIG. 6 is another cross-sectional view showing the operation of the tire inflation tool according to the preferred embodiment of the present invention.

FIG. 7 is also another cross-sectional view showing the operation of the tire inflation tool according to the preferred embodiment of the present invention.

FIG. 8 is still another cross-sectional view showing the operation of the tire inflation tool according to the preferred embodiment of the present invention.

FIG. 9 is another cross-sectional view showing the operation of the tire inflation tool according to the preferred embodiment of the present invention.

### DETAILED DESCRIPTION

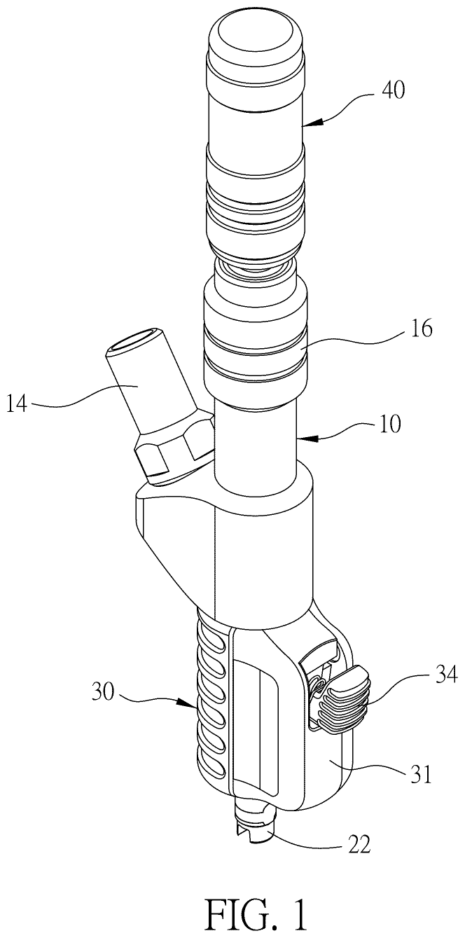

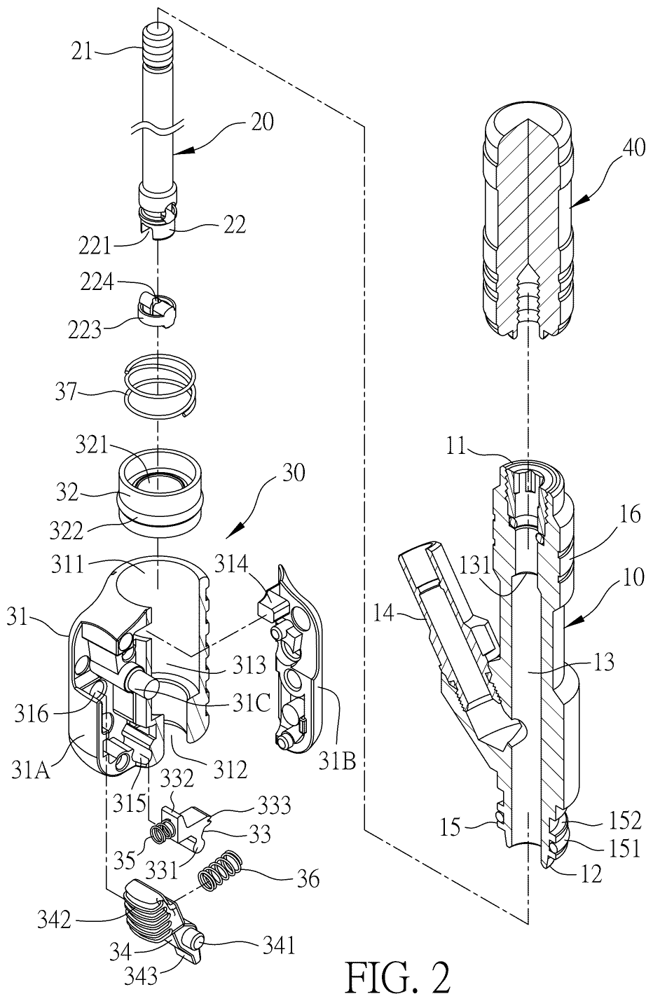

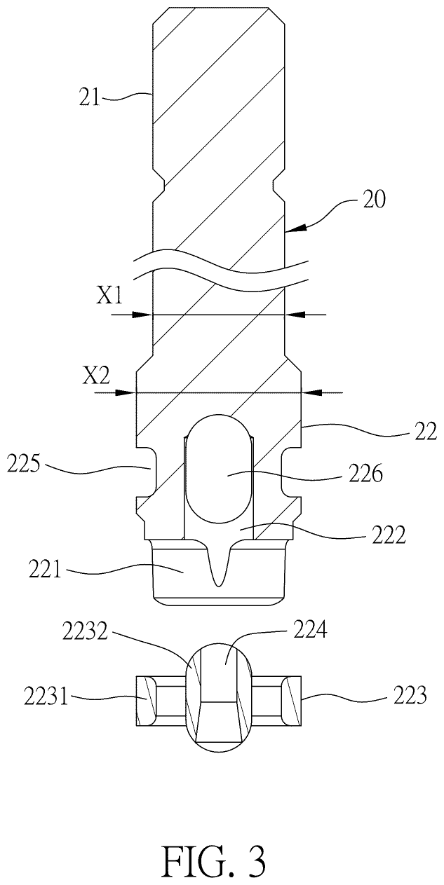

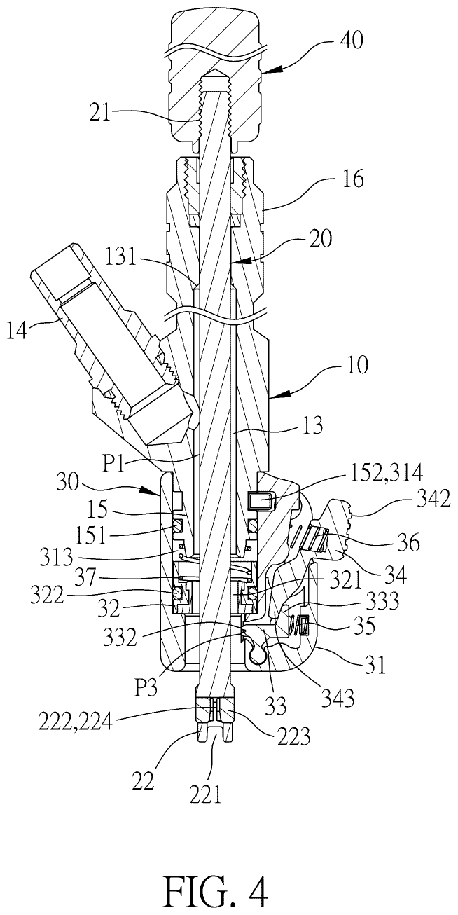

With reference to FIGS. 1-4, a tire inflation tool with a valve removal function according to a preferred embodiment of the present invention comprises: a fitting tube 10, a driving rod 20, an air connector 30, and an operation element 40.

The fitting tube 10 includes a first segment 11, a second segment 12 opposite to the first segment 11, and an air conduit 13 communicating with the first segment 11 and the second segment 12, wherein the air conduit 13 has a defining portion 131 formed adjacent to the second segment 12, and the defining portion 131 is a hole with a decreased diameter. An inlet joint 14 is defined between the first segment 11 and the second segment 12 of the fitting tube 10 and is communicated with the air conduit 13, and a coupling portion 15 is formed on the first segment 11 of the fitting tube 10, wherein a diameter of the coupling portion 15 is greater than a diameter of the fitting tube 10, and the coupling portion 15 has an O ring 151 engaged on an outer wall thereof and has a limiting groove 152 defined around the outer wall of the coupling portion 15, wherein the fitting tube 10 further includes a grip portion 16 formed on the second segment 12.

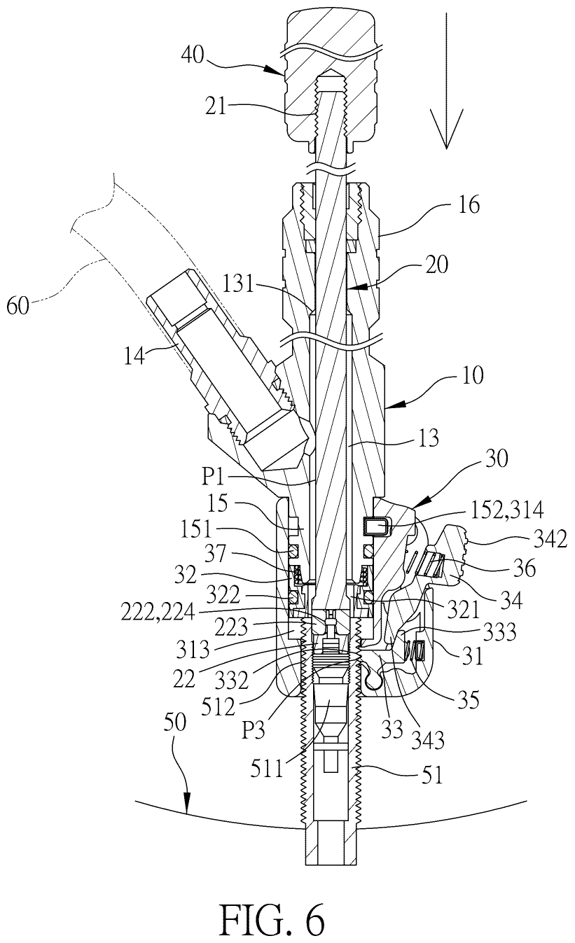

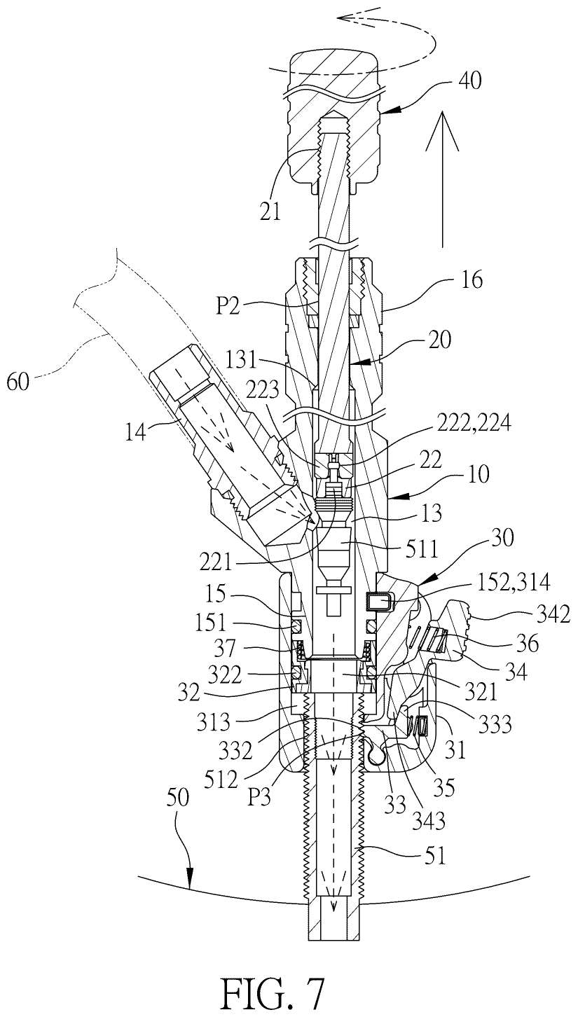

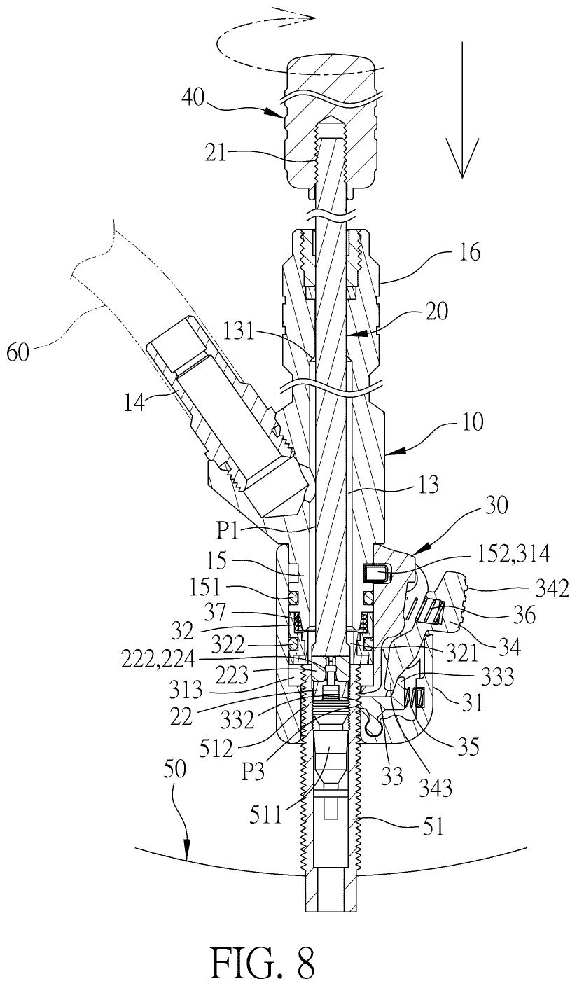

The driving rod 20 is movable and rotatable reciprocally between a first position P1 (as shown in FIGS. 6 and 8) and a second position P2 (as illustrated in FIG. 7). The driving rod 20 includes a first diameter X1, a manipulation portion 21 extending out of an outer wall of the second segment 12 of the fitting tube 10 from an end of the driving rod 20, and a take portion 22 formed on the other end of the driving rod 20, wherein the take portion 22 has a second diameter X2 which is greater than the first diameter X1. When the driving rod 20 is moved toward the second position P2, the take portion 22 is stopped by the defining portion 131 of the fitting tube 10, thus limiting the take portion 22.

The take portion 22 includes a groove 221 defined on a front end thereof, a recessed portion 222 formed on a bottom of the groove 221, a flexible block 223 fixed on the take portion 22, and a connection orifice 224 extending into the recessed portion 222 from the flexible block 223. The take portion 22 has a trench 225 with at least one locking orifice 226 (in this embodiment, two locking orifices 226 are formed on the trench 225) which is communicated with the recessed portion 222, wherein the flexible block 223 is a one-piece injection molded on the take portion 22 and has a surround portion 2231 connected with the trench 225, and the flexible block 223 has at least one engagement portion 2232 engaged with the at least one locking orifice 226 (in this embodiment, two engagement portions 2232 are provided), wherein the connection orifice 224 corresponds to the two engagement portions 2232, thus decreasing components and saving connection processes.

The air connector 30 includes a seat 31, an air stop ring 32, at least one movable retainer 33, a control element 34, at least one returning element 35, 36, and a force spring 37.

The seat 31 has a cap 31B connected with a body 31A, a chamber 31C defined between the body 31A and the cap 31B, wherein the seat 31 further has a first fixing orifice 311 formed on an end thereof, a second fixing orifice 312 formed on the other end of the seat 31, a channel 313 defined and communicated between the first fixing orifice 311 and the second fixing orifice 312, and a projection 314 received in the channel 313, wherein the first fixing orifice 311 is configured to accommodate the coupling portion 15 of the fitting tube 10, and an inner wall of the channel 313 abuts against the O ring 151 of the coupling portion 15 to obtain an air tightness and to avoid an air leakage. The projection 314 is engaged in the limiting groove 152 of the coupling portion 15 to limit a rotation and a removal of the seat 31 relative to the fitting tube 10. The chamber 31C is located beside the first fixing orifice 311, the second fixing orifice 312 and the channel 313, and the chamber 31C has a first rotatable connection portion 315 proximate to the second fixing orifice 312 and a third rotatable connection portion 316 adjacent to the channel 313.

The air stop ring 32 is received in the channel 313 but does not block the first fixing orifice 311 and the second fixing orifice 312, wherein the air stop ring 32 is moved toward the first fixing orifice 311 or the second fixing orifice 312 in the channel 313, and the air stop ring 32 has a passageway 321 defined therein, and the sir stop ring 32 has an air-tight portion 322 extending from an outer wall thereof to stop and close air with the channel 313.

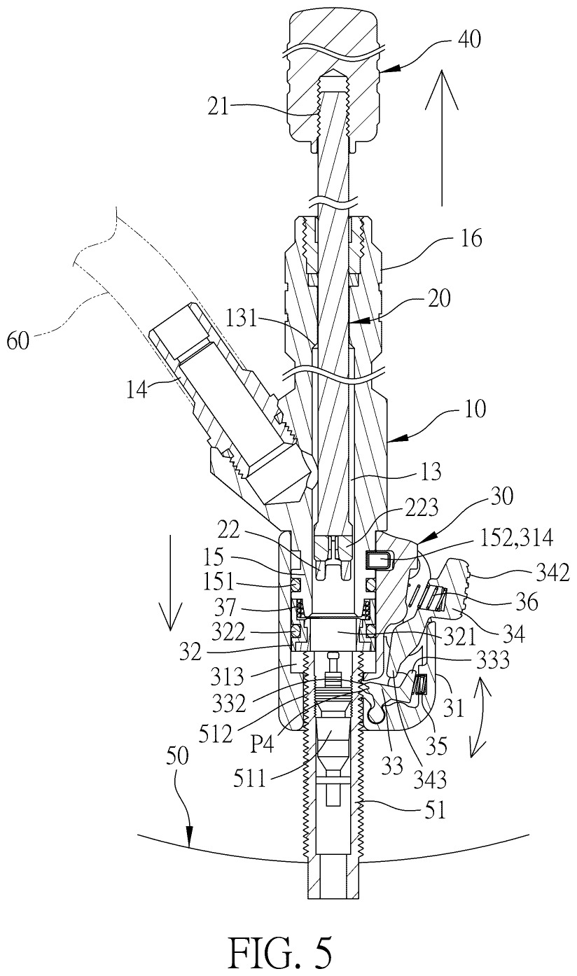

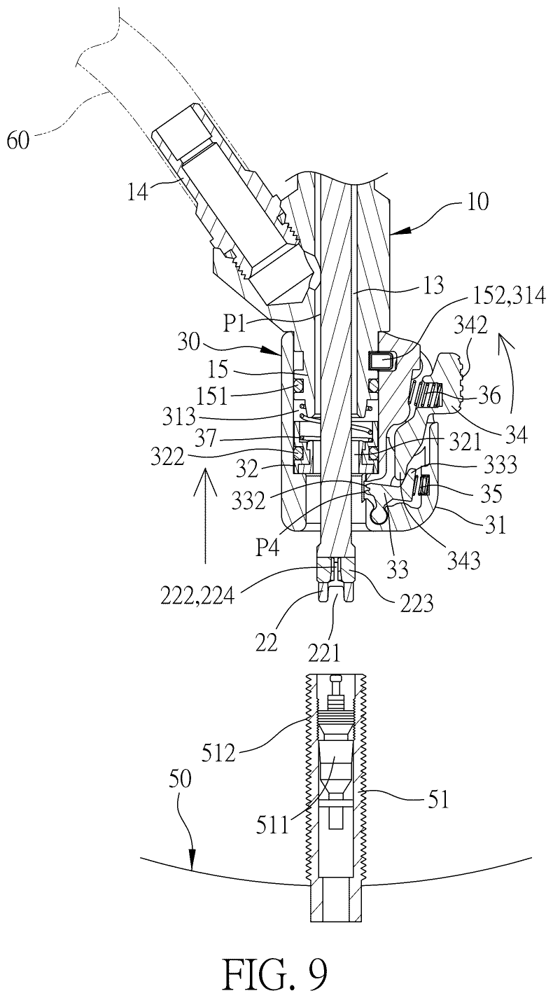

In this embodiment, a movable retainer 33 is provided and is received in the chamber 31C of the seat 31 adjacent to the second fixing orifice 312, wherein the movable retainer 33 has a second rotatable connection portion 331 which is rotatably connected with the first rotatable connection portion 315 of the seat 31, the movable retainer 33 has a toothed portion 332 formed on an inner wall thereof and an actuation portion 333 extending from an outer wall of the movable retainer 33, wherein the toothed portion 332 is controlled to move between an internal position P3 (as shown in FIGS. 6-8) and an external position P4 (as illustrated in FIGS. 5 and 9), wherein the internal position P3 is located in the channel 313, and the external position P4 is located outside the channel 313 and in the chamber 31C.

In this embodiment, a control element 34 is provided, wherein the control element 34 is received in the chamber 31C of the seat 31, and the control element 34 has a fourth rotatable connection portion 341 configured to rotatably connect with the third rotatable connection portion 316 of the seat 31, a manual drive portion 342 formed on an outer wall of the control element 34 and configured to be manually controlled, a controlled portion 343 formed on an inner wall of the control element 34 and driven by the actuation portion 333 of the movable retainer 33. When the manual drive portion 342 is pressed, the controlled portion 343 is driven by the manual drive portion 342 to actuate the movable retainer 333 of the actuation portion 33 to move outward so that the toothed portion 332 of the movable retainer 33 is moved between the internal position P3 and an external position P4.

In this embodiment, two returning elements 35, 36 are mounted among the seat 31, the control element 34 and the movable retainer 33, wherein when the toothed portion 332 of the movable retainer 33 is maintained at the internal position P3 and the manual drive portion 342 of the control element 34 is pressed, the two returning elements 35, 36 are forced to move the actuation portion 333 of the movable retainer 33, and the toothed portion 332 of the movable retainer 33 is moved toward the external position P4. In this embodiment, the two returning elements 35, 36 are a spring.

The force spring 37 is disposed between the coupling portion 15 of the fitting tube 10 and the air stop ring 32 of the air connector 30 and is configured to push the air stop ring 32 to the second fixing orifice 312.

The projection 314 is a one-piece injection molded with the cap 31B, when the cap 31B is connected with the body 31A, and the projection 314 is engaged in the limiting groove 152 of the coupling portion 15, thus fixing the seat 31. In the meantime, the coupling portion 15 of the fitting tube 10, the air stop ring 32, the movable retainer 33, the control element 34, the two returning elements 35, 36 and the force spring 37 are fixed in the seat 31.

The operation element 40 is connected with the manipulation portion 21 of the driving rod 20 to operate the driving rod 20 easily.

Referring to FIG. 5, the tire inflation tool is connected to a tire valve 51 of a tire 50 to inflate the air, wherein the tire valve 51 includes an air valve 511 configured to inflate and discharge the air into and from the tire 50, and the tire valve 51 has threads 512 formed on an outer wall thereof adjacent to an edge of the tire valve 51. In use, the seat 31 of the air connector 30 is fitted on the tire valve 51 via the second fixing orifice 312 so as to insert the edge of the tire valve 51 into the channel 313 from the second fixing orifice 312 with a user's one-hand, and the toothed portion 332 of the movable retainer 33 is pushed by the threads 512 and the two returning elements 35, 36 to movably open between the internal position P3 and the external position P4, hence the tire valve 51 is inserted to a predetermined position. The toothed portion 332 of the movable retainer 33 engages with the threads 512 of the tire valve 51, and the edge of the tire valve 51 abuts against the air stop ring 32 to press the force spring 37 so that the air tightness effect and the anti-leakage produce between the edge of the tire valve 51 and the air stop ring 32, then an air pipe 60 of the tire inflation tool is connected with the air joint 14 of the fitting tube 10.

As shown in FIG. 6, the driving rod 20 is moved toward the first position P1 so that the groove 221 of the take portion 22 is engaged with the air valve 511 of the tire valve 51, wherein a part of the air valve 511 is inserted into the recessed portion 222 of the take portion 22 and the connection orifice 224 of the flexible block 223, and the flexible block 223 moves back to engage with the air valve 511, thus connecting the air valve 511 with the take portion 22 stably.

As illustrated in FIG. 7, the operation element 40 actuates the driving rod 20 to rotate, the take portion 22 actuates the air valve 511 to rotate and remove from the tire valve 51, and the driving rod 20 is moved toward the second position P2 to actuate the air valve 511 to remove from the tire valve 51 completely so that the air conduit 13 of the fitting tube 10 is communicated with the tire 50 via the passageway 321 of the air stop ring 32 and the tire valve 51, thus increasing an inflating area of the air. Preferably, the tire inflation tool inflates the air into the tire 50 quickly (such as a large-size tire), and the tire inflation tool is detachable from the tire valve 51 with the air valve 511, thus removing the air valve 511 completely.

With reference to FIG. 8, after inflating the air into the tire 50, the driving rod 20 is moved toward the first position P1 so that the take portion 22 actuates the air valve 511 to insert into the tire valve 51 again, then the operation element 40 drives the driving rod 20 to move reversely, wherein the take portion 22 actuates the air valve 511 to rotate and to screw with the tire valve 51, hence the air valve 511 is connected with the tire valve 51, thus closing the tire valve 51.

Referring to FIG. 9, the manual drive portion 342 of the control element 34 is pressed so that the control element 34 presses the returning element 36, and the controlled portion 343 of the control element 34 rotates along the fourth rotatable connection portion 341 to move the actuation portion 333 of the movable retainer 33, and the movable retainer 33 presses the returning element 35, wherein the toothed portion 332 of the movable retainer 33 rotates along the second rotatable connection portion 331 so that the toothed portion 332 of the movable retainer 33 moves from the internal position P3 to the external position P4, and the air connector 30 disengages from the tire valve 51, thus removing the tire inflation tool from the tire valve 51.

Therefore, the tire inflation tool has the following advantages:

The tire inflation tool is connected with the tire valve 51 of the tire 50 by using the air connector 30 to inflate the air, and the air connector 30 is removed from the tire valve 51 by mating with the fitting tube 10 and the driving rod 20, after inflating the air with the user's one hand, hence the air is inflated into the tire 50 easily and quickly, and the air valve is removed, thus obtaining easy operation and time and labor-saving.

The take portion 22 is simplified and connected easily, and the flexible block 223 is connected with the take portion 22 stably to reduce a fabrication cost and prolong a service life.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A tire inflation tool being configured to connect to a tire valve of a tire, the tire valve including an air valve configured to inflate and discharge the air into and from the tire, the tire inflation tool comprising:
a fitting tube including a first segment, a second segment opposite to the first segment, and an air conduit communicated with the first segment and the second segment, wherein an inlet joint is defined between the first segment and the second segment of the fitting tube and is communicated with the air conduit, and a coupling portion is formed on the first segment of the fitting tube;
a driving rod being movable and rotatable reciprocally between a first position and a second position, the driving rod including a manipulation portion extending out of an outer wall of the second segment of the fitting tube from an end of the driving rod, and a take portion formed on the other end of the driving rod, wherein when the driving rod is moved toward the first position, the take portion is connected with the air valve of the tire valve and actuates the air valve to rotate so as to remove or connect the air valve from or with the tire valve, and when the driving rod actuates the air valve to move toward the second position, the tire is communicated with an external environment via the tire valve, the air conduit and the inlet joint, thus increasing an inflating area of air;
an air connector including a seat, an air stop ring, at least one movable retainer, a control element, and at least one returning element;
wherein the seat has a first fixing orifice formed on an end thereof, a second fixing orifice formed on the other end of the seat, a channel defined and communicated between the first fixing orifice and the second fixing orifice, wherein the first fixing orifice is configured to accommodate the coupling portion of the fitting tube, and the second fixing orifice is configured to accommodate the tire valve;
wherein the air stop ring is received in the channel but does not block the first fixing orifice and the second fixing orifice, the air stop ring is moved toward the first fixing orifice or the second fixing orifice in the channel, wherein the air stop ring has a passageway defined therein, and the air stop ring has an air-tight portion extending from an outer wall thereof to stop and close air with the channel;
wherein the movable retainer is rotatably with the seat adjacent to the second orifice, the movable retainer has a toothed portion formed on an inner wall thereof and an actuation portion extending from an outer wall of the movable retainer, wherein the toothed portion is controlled to move between an internal position and an external position, the internal position is located in the channel, and the external position is located outside the channel;
wherein the at least one returning element is configured to abut against the movable retainer so as to maintain the toothed portion at the internal position, and when the at least one returning element actuates the actuation portion, the toothed portion of the movable retainer is moved toward the external position.

2. The tire inflation tool as claimed in claim 1, wherein the seat has a projection received in the channel, the coupling portion has an O ring engaged on an outer wall thereof and has a limiting groove defined around the outer wall of the coupling portion, wherein an inner wall of the channel abuts against the O ring of the coupling portion to obtain an air tightness and to avoid an air leakage, the projection is engaged in the limiting groove to limit a rotation and removal of the seat relative to the fitting tube.

3. The tire inflation tool as claimed in claim 1, wherein the take portion includes a groove defined on a front end thereof, a recessed portion formed on a bottom of the groove, a flexible block fixed on the take portion, wherein the take portion has a trench with at least one locking orifice which is communicated with the recessed portion, the flexible block is a one-piece injection molded on the take portion and has a surround portion connected with the trench, and the flexible block has at least one engagement portion engaged with the at least one locking orifice, wherein a connection orifice is defined between the two engagement portions and extends into the recessed portion.

4. The tire inflation tool as claimed in claim 1, wherein the fitting tube further includes a grip portion formed on the second segment.

5. The tire inflation tool as claimed in claim 1 further comprises an operation element connected with the manipulation portion of the driving rod to operate the driving rod easily.

6. The tire inflation tool as claimed in claim 1, wherein the air conduit of the fitting tube has a defining portion formed adjacent to the second segment, and the defining portion is a hole with a decreased diameter, wherein the driving rod includes a first diameter, the take portion of the driving rod has a second diameter which is greater than the first diameter, when the driving rod is moved toward the second position, the take portion is stopped by the defining portion of the fitting tube, thus limiting the take portion.

7. The tire inflation tool as claimed in claim 1, wherein the air connector further includes the at least one control element, the control element is rotatably received in the seat and is pushed by the at least one returning element, and the at least one control element has a manual drive portion formed on an outer wall thereof and configured to be manually controlled, a controlled portion formed on an inner wall of the control element and driven by the actuation portion of the movable retainer, when the manual drive portion is pressed, the controlled portion is driven by the manual drive portion to actuate the movable retainer of the actuation portion to move outward so that the toothed portion of the movable retainer is moved between the internal position and the external position.

8. The tire inflation tool as claimed in claim 1, wherein the air connector further includes a force spring disposed between the coupling portion of the fitting tube and the air stop ring of the air connector and is configured to push the air stop ring to the second fixing orifice.

9. The tire inflation tool as claimed in claim 2, wherein the seat has a cap connected with a body, a chamber defined between the body and the cap, wherein the projection is a one-piece injection molded with the cap, when the cap is connected with the body, the coupling portion of the fitting tube, the air stop ring, the movable retainer, and the at least one returning element is fixed in the seat.
